(19) United States
(12) Patent Application Publication
(10) Pub. No.: US 2023/0419306 A1
(43) Pub. Date: Dec. 28, 2023

(54) NON-FUNGIBLE TOKEN DISTRIBUTION, DISPLAY AND STORAGE SYSTEM USING MOBILE SMARTPHONE WALLETS

(71) Applicant: CounterTEN, Inc., San Diego, CA (US)

(72) Inventor: Steven P. Shulman, San Diego, CA (US)

(21) Appl. No.: 18/215,157

(22) Filed: Jun. 27, 2023

Related U.S. Application Data
(60) Provisional application No. 63/356,473, filed on Jun. 28, 2022.

(51) Int. Cl. G06Q 20/36; H04L 9/08; H04L 9/32

(52) U.S. Cl. CPC G06Q 20/3678; H04L 9/088; H04L 9/3263

(57) ABSTRACT

Methods and systems related to NFT distribution, display, and management are disclosed herein. The systems allow NFT owners to efficiently manage their NFTs without the need to implement complex cryptographic algorithms and blockchain technologies. A disclosed system for downloading and showcasing an NFT is a wallet bundle generator which generates an NFT owner identifier for an NFT, formats the NFT owner identifier for a data exchange format, generates an electronic card which includes the NFT owner identifier and is in the data exchange format, generates a bundle by signing the electronic card using a private key, and distributes the bundle to an owner device via a network. The bundle can be compatible with a mobile wallet application such as the Apple or Google Wallet application. The owner can then add the bundle to their wallet, and thereafter efficiently present the NFT owner identifier for verification using the mobile wallet application.

### CROSS REFERENCE TO RELATED APPLICATIONS

This application claims the benefit of U.S. Provisional Patent Application No. 63/356,473 which was filed on Jun. 28, 2022, and which is incorporated by reference herein in its entirety for all purposes.

### BACKGROUND

Non-fungible tokens (NFTs) are ledger entries stored on a blockchain that indicate both an ownership right of a distinct asset and an owner of that ownership right. Common NFTs include those minted using the ERC-721 and ERC-1155 standards on the Ethereum blockchain and the Metaplex Protocol on the Solana blockchain. In these examples, the ledger entry includes an NFT identifier associated with the distinct asset, paired with a public identifier associated with the owner. The public identifier associated with the owner can be referred to as the public wallet identifier for the owner. The ledger entry can be located in the blockchain using an NFT address. In other words, the NFT address can be used to search the blockchain to find the NFT identifier and the public wallet identifier.

The ownership rights and distinct assets represented by NFTs have rapidly proliferated to include a wide array of assets from digital artwork and the associated copyrights, in-game items for massively multiplayer online games, real estate, automobiles, event tickets, and many others. The rights represented by the NFTs are also widespread and include basic fee simple rights in property, joint property ownership, share allocated property ownership, temporally allocated ownership rights to facilitate scheduled shared ownership for joint owners, and many others. As the number of assets increases, it is becoming more difficult for owners to manage their various NFTs.

NFT ownership management is difficult for several reasons. For example, the NFTs may be minted across a multitude of blockchains with each requiring a slightly different system to access. Furthermore, even in the case of a single blockchain storing all the NFTs a user may currently own, the owner will still need to understand how the blockchain works to showcase their ownership or prove that they are truly the owner. Generally, they will also need to access the blockchain many times for each NFT they own in order to showcase or verify their ownership. Currently, there is no ubiquitous system for storing and visually displaying all the NFTs a person may own. This creates problems from a management perspective for an owner and makes it difficult for an owner to showcase their NFTs or present them quickly for verification.

Until the complexities associated with the cryptographic algorithms and other blockchain technologies that underly the ownership of NFTs can be fully masked from an owner of the NFTs, the widespread adoption of NFTs to represent ownership rights will be dampened. Solutions which mask such complexities and allow owners to manage their NFTs in a frictionless and efficient manner without the need to understand and implement complex cryptographic algorithms or interact with the blockchain can provide significant benefit and lead to significant technological advancement.

### SUMMARY

This disclosure relates generally to token management and more specifically to non-fungible token (NFT) management. As used in this disclosure, management can refer to one or more of downloading, organizing, showcasing, displaying, safeguarding, and manipulating NFT data. Using specific embodiments of the systems and methods disclosed herein, individuals that own NFTs can download, showcase, and manage NFTs without the need to execute complex cryptographic algorithms. Furthermore, using specific embodiments of the systems and methods disclosed herein, individuals that want to market NFTs can package the NFT into an informative and appealing visual format which can be fluidly added into a potential buyer's collection upon consummation of their transaction.

Specific embodiments of the inventions disclosed herein include approaches which involve cooperation between various parties. As used herein, the term “owner” will refer to an entity that owns an ownership right represented by an NFT generally through a purchase of an NFT from an issuer or through registering their NFT with an issuer. As used herein, the term “issuer” will refer to an entity that markets an NFT to a potential owner or that registers an NFT for an owner and that issues an electronic representation of the NFT to the potential owner or owner. An issuer is not necessarily the same party that has minted the NFT. Furthermore, an issuer is not necessarily the same party that physically administrates the distribution of the electronic representation of the NFT to the owner. Indeed, using some of the approaches disclosed herein an issuer can market NFTs for potential owners or register NFTs for current owners, and assure that electronic representations of those NFTs are distributed accordingly, without any knowledge regarding the intricacies of how an NFT is minted on or transferred on a blockchain. As used herein, the term “issuance administrator” refers to an entity that administrates a blockchain shell system, a bundle generating system, or that mints NFTs, as those systems and processes are described herein, and that handles interfacing with the blockchain on behalf of an issuer or directly on behalf of an owner to physically distribute electronic representations of NFTs to owners or potential owners. As used herein, the term “verifier” will refer to an entity that needs to verify the ownership of an NFT or that is interested in obtaining additional information regarding an NFT from an owner. As used herein, the term “wallet application administrator” refers to a party that administrates a wallet application and that can provide an issuance administrator with the ability to generate and distribute electronic representations of NFTs that are compatible and verified for use with the electronic wallet application.

In specific embodiments disclosed herein, NFT management can be achieved using a wallet bundle generator and an associated wallet application to provide for the efficient generation, distribution, and storage of NFT data for NFT owners. For example, the wallet application could be the Apple or Google mobile wallet applications and the wallet bundle generator could generate a bundle compatible with the Apple or Google Wallet which includes data for presenting a visual representation of the NFT, along with any metadata, and verifying ownership of the NFT. In specific embodiments, NFT ownership can be registered and verified using a blockchain shell that provides an interface between the blockchain and users that are interested in verifying NFTs without those users needing to interact directly with the blockchain or administrate the execution of cryptographic algorithms. Furthermore, in specific embodiments disclosed herein, the ownership of an NFT can be verified without any party needing to execute a cryptographic algorithm thereby reducing the computational resources consumed in the verification of NFT ownership.

In specific embodiments disclosed herein, NFT ownership can be registered for a specific owner, and the owner could be provided with a bundle including data for an NFT owner identifier that could be stored in a wallet application of the owner. The wallet application can be compatible with an owner device such as a smartphone. The NFT owner identifier could be associated with an NFT and be stored in the wallet application alongside any number of other NFTs. The wallet application could be programmed to display a physical representation of the NFT, a physical representation of an NFT owner identifier, and/or a physical representation of a blockchain address of the NFT. The alternative NFTs could be generated by the same wallet bundle generator (e.g., associated with a single issuance administrator) and stored in the wallet application of a single user (e.g., an owner) while each of the NFTs was associated with a different entity (e.g., different issuers). The owner could then use the wallet application to store their NFTs and present the appropriate NFT to either showcase their collection or to allow for the verification of their ownership (e.g., by one or more verifiers).

In specific embodiments of the invention, both issuers and owners of NFTs benefit from the methods and systems disclosed herein. Issuers benefit from a potential increase in usage or purchase price for their NFTs attributable to the convenience of being compatible with a central system for managing the NFTs. Owners benefit from being able to conveniently add their NFT to a central location and from being able to fluidly showcase and manage their collection. Furthermore, there is little friction to the adoption of these methods and systems because the paradigm utilized will already be familiar to users from the use of digital boarding electronic cards and store cards in mobile smartphone wallets. The resulting increase in adoption will, through network affects, further benefit both issuers and owners.

The example of an NFT associated with a distinct asset in the form of the right to occupy a space in a live event such as a concert, conference, or professional sports event is illustrative of specific embodiments of the invention. The host of the event could be an issuer of the NFT. The host could be able to design the visual representation of their NFT by selecting illustrations, colors, the layout, text, and the NFT data such as the address of the NFT on the blockchain. The administrator could then generate a bundle for distribution to the wallet application of the specific ticket holder for the event (e.g., an owner) that included all the data selected by the issuer so that when the bundle was downloaded by the new owner it would appear in their mobile smartphone wallet with the appearance selected by the issuer. The owner could be a purchaser of a ticket to the live event and the bundle could be downloadable from the Internet using the same portal the owner used to purchase the ticket.

In specific embodiments of the invention, a method for generating and distributing an NFT owner identifier is provided. The method includes generating the NFT owner identifier for an NFT, formatting the NFT owner identifier for a data exchange format, and generating an electronic card. The electronic card includes the NFT owner identifier and is in the data exchange format. The method also includes generating a bundle by signing the electronic card using a private key and distributing the bundle to an owner device via a network. The bundle is compatible with a wallet application. A certificate associated with the private key is signed by a developer of the wallet application.

In specific embodiments of the invention, a method for distributing an NFT owner identifier is provided. The method includes obtaining an NFT owner identifier for an NFT and generating an electronic representation of the NFT. The electronic representation includes the NFT owner identifier. The method also includes generating a bundle that includes the electronic representation and distributing the bundle to an owner device via a network.

In specific embodiments of the invention, a system for generating and distributing an NFT owner identifier is provided. The system includes a memory storing an NFT owner identifier for an NFT and a representation generating module configured to generate an electronic representation of the NFT. The electronic representation includes the NFT owner identifier. The system also includes a bundle generating module configured to generate a bundle. The bundle includes the electronic representation and wherein the bundle is addressed for distribution to an owner device via a network.

### BRIEF DESCRIPTION OF THE DRAWINGS

FIG. 1 is a rendering of the user interface of an electronic wallet application on a mobile device showing a selection screen for a collection of electronic cards stored in the electronic wallet application and a display screen for a particular electronic card in the form of an electronic representation of an NFT in accordance with specific embodiments of the inventions disclosed herein.

FIG. 2 is a rendering of the electronic card in the wallet application on the owner device from FIG. 1 with an NFT owner identifier in the form of a QR code for presentation on the owner device in accordance with specific embodiments of the inventions disclosed herein.

FIG. 3 is a rendering of an ownership verification page of an NFT for presentation on a verifier device in accordance with specific embodiments of the inventions disclosed herein.

FIG. 4 is a flow chart for a set of methods for distributing an electronic representation of an NFT in accordance with specific embodiments of the inventions disclosed herein.

FIG. 5 is a block diagram for a system for distributing an electronic representation of an NFT in accordance with specific embodiments of the inventions disclosed herein.

FIG. 6 includes a block diagram for a system and a flow chart for a set of methods for verifying an NFT owner identifier in accordance with specific embodiments of the inventions disclosed herein.

FIG. 7 includes a block diagram for a system and a flow chart for a set of methods for accessing information from a blockchain based on an electronic representation of an NFT in accordance with specific embodiments of the inventions disclosed herein.

FIG. 8 includes a block diagram for a system for accessing information from a plurality of blockchains based on an electronic representation of an NFT in accordance with specific embodiments of the inventions disclosed herein.

FIG. 9 includes a block diagram for a system and a flow chart for a set of methods for providing an issuer with network accessible tools for defining an electronic representation of an NFT in accordance with specific embodiments of the inventions disclosed herein.

FIG. 10 includes a block diagram for a system and a flow chart for a set of methods for receiving a certification for a private key to be used to generate a bundle including the electronic representation of the NFT in accordance with specific embodiments of the inventions disclosed herein.

FIG. 11 includes a flow chart for a set of methods for minting an NFT and distributing an electronic representation of the NFT in accordance with specific embodiments of the inventions disclosed herein.

FIG. 12 is a screen shot of the pass details page for an electronic representation of an NFT in a wallet application.

FIG. 13 is a partial screen shot of additional information that can be provided to a verifier device, or to an owner device, in connection with an electronic representation of an NFT in a wallet application in the form of statistics for an athletic collectible card.

FIG. 14 is a partial screen shot of additional information that can be provided to a verifier device, or to an owner device, in connection with an electronic representation of an NFT in a wallet application in the form of a player summary for an athletic collectible card.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods associated with token management in accordance with the summary above will be described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Methods for managing a nonfungible token (NFT) in accordance with the summary above comprise several steps. The steps can be conducted by a system including a bundle generating system providing management and distribution services. For example, the steps of formatting an NFT owner identifier, generating an electronic card, generating a bundle by signing the electronic card, and distributing the bundle can all be conducted by a system instantiated by one or more servers providing management and distribution services. The bundle generating system can have access to one or more certificate signing requests servers operated by the developers of one or more wallet applications (e.g., wallet application administrators). The bundle generating system can be implemented by one or more servers and one or more databases. The steps can also be conducted by a system including a blockchain shell system providing verification services. For example, the steps of receiving an NFT owner identifier, verifying ownership of an NFT, and returning ownership verification data in accordance with the summary above can all be conducted by a blockchain shell system. The blockchain shell can be a web accessible service or can be accessed through APIs accessed by applications stored on various devices. The blockchain shell system can be implemented by one or more servers and one or more databases. The blockchain shell can have access to one or more blockchains for which it is providing verification services.

Various parties are mentioned throughout this disclosure relative to different aspects of the systems and methods disclosed herein. Generally, the verifiers, owners, and issuers are, in various embodiments, shielded from the complexity of blockchain technology and are given tools to manage, safeguard, and efficiently verify the ownership rights of NFTs by an issuance administrator. For example, an issuer could be a concert promoter that wants to issue tickets to a concert that will be represented by NFTs. In specific embodiments of the invention, the issuer and verifier will be the same party to the transaction (e.g., the concert promoter will also administrate verification of ownership of the NFTs when controlling access to the concert). However, the issuer and verifier can often be separate parties. An issuance administrator can be an entity that runs a bundle generating system for generating the electronic representations of the NFTs, and the blockchain shell system, and operates them to provide verification services for owners and verifiers. The issuance administrator can likewise administrate the bundle generating system and distribute bundles with associated NFT data for owners and issuers.

The steps of the methods for managing NFTs can be executed by various devices held by an issuer, owner, or issuance administrator. The steps could be conducted by an issuer device with a network connection to a portal offered by the administrator for designing a visual representation of an NFT. The steps could also be conducted by an owner device operated by a user who owns the NFT and is attempting to showcase their collection or allow a verifier to verify their NFT ownership (i.e., an owner). In specific implementations, the owner device can be a smartphone wallet and include a mobile smartphone wallet application and a network connection. The owner device can use the network connection to receive a bundle that includes data representing the NFT owner identifier, or other data associated with the NFT, and can use the wallet application to store the bundle as a card or electronic card in the wallet application. The bundle can be distributed and received over a network connection using a web user interface provided by the administrator, by delivering the bundle via an application programming interface on an application administrated by the issuance administrator on an owner device, or by sending the bundle to an owner device in an email or other electronic communication where the bundle can be downloaded and saved to the device. The bundle could then be opened using a wallet application such that the NFT data was safeguarded by and accessible from the wallet application. In specific implementations, the owner device can do one or more of: storing the NFT owner identifier and presenting the NFT owner identifier to a verifier device.

A blockchain shell system in accordance with specific embodiments of the invention disclosed herein can verify ownership of an NFT in various ways. The system can verify ownership on demand in response to a request from a verifier and ex ante in response to an action taken by or on behalf of the owner. In either case, ownership verification can be conducted as part of a registration of the NFT with the system. Registration of the NFT with the system provides certain benefits in that later verification requests can be conducted entirely within the blockchain shell system and may only require a double check review of the public information on the associated block chain to confirm ownership. NFT ownership verification conducted entirely within the blockchain shell system can be conducted using an NFT owner identifier that has been issued by the blockchain shell system. NFT ownership verification generally can also be conducted with an NFT owner identifier directly associated with the blockchain itself such as a public wallet identifier for the NFT.

A bundle generating system in accordance with specific embodiments of the invention disclosed herein can generate and distribute a bundle to an owner device in various ways. The bundle generator can operate in combination with the blockchain shell system. The bundle generator could obtain an NFT owner identifier from the blockchain shell system, generate an NFT owner identifier in combination with the blockchain shell system, or independently generate an NFT owner identifier.

In specific embodiments of the invention, generating a bundle for an NFT can include generating an electronic representation of an NFT that is compatible with a wallet application such as a mobile smartphone wallet application. The bundle can include data for a physical representation of the NFT owner identifier and/or data for a physical representation of the blockchain address of the NFT. The example of an electronic card is used throughout this disclosure as an example of an electronic representation of an NFT that is compatible with a wallet application, but this is only for purposes of explaining the invention and is not a limitation of the invention. The electronic card can include the NFT owner identifier. The electronic card can be in a data exchange format such as JavaScript Object Notation (JSON). The electronic card can include additional data such as a company name of an issuer for the NFT, an NFT serial number, an NFT type, an NFT image (to be presented by the wallet application, or optional details regarding the NFT and electronic card. The NFT serial number can be a number reserved for use by the issuer or could itself by the NFT owner identifier. The electronic card can also include data for visual representations of the NFT owner identifier such as an encoding used to check a blockchain entry associated with the NFT or an encoding of the NFT owner identifier. All the data for the electronic card can be in the same data exchange format. Accordingly, the process of generating the electronic card can include formatting the NFT owner identifier, or any other data associated with the NFT, into the data exchange format. The data that is put into the data exchange format will ultimately be displayed in the mobile smartphone wallet application of the owner. As such, the data can include specific instructions for rendering using a format associated with the mobile smartphone wallet application.

In specific embodiments of the invention, generating a bundle for an NFT can be conducted in various ways. The bundle can include the electronic card as signed using a private key. The private key can be associated with a certificate that is signed by a developer of the wallet application (i.e., a wallet application administrator). For example, the developer of the wallet application could require the receipt of a certificate signing request from a party that was interested in generating bundles for NFTs that are compatible with the wallet application. The process of generating the bundles could thereby include generating a certificate signing request for the developer of the wallet application and receiving a certification for the private key in exchange for the certificate signing request. The certified private key could then be used to sign the electronic card and generate the bundle. The bundle generator could be required to generate a public private key pair according to an encryption protocol selected by the developer as a prerequisite to generating the certificate signing request.

In specific embodiments of the invention, the developer could require different certificates for each administrator interested in generating bundles, each issuer that an administrator will be responsible for generating bundles for, or for each type of NFT for which bundles will be generated. The bundles can include unique serial numbers for different variants of the specific types of NFTs to distinguish them and allow the same private key to sign the associated electronic cards. The bundle can include any data associated with the NFT and can be provided to a wallet application to allow the wallet application to manage and present that data, or variants thereof, for verification. The data associated with the NFT can be an NFT owner identifier for the NFT which is generated during the registration process.

Ex ante ownership verification and registration of an NFT in accordance with specific embodiments of the invention disclosed herein can be conducted in various ways. Ex ante ownership verification of an NFT can be conducted by the blockchain shell system minting the NFT, by the blockchain shell system administrating a transfer of ownership of the NFT on a secondary market administrated by the blockchain shell system, or by the blockchain shell system onboarding an NFT at the request of the owner. In the case of minting an NFT or administrating a secondary market for the NFT, the blockchain shell system provides ownership verification services as it records who the owner of the newly minted NFT is or who the current owner of the NFT is on the secondary market. In the case of minting the NFT or administrating the transfer of the NFT, registering the NFT with the blockchain shell system can include creating an entry on the blockchain with an NFT owner identifier that directly identifies the owner, or by updating the internal records of the blockchain shell system while a custodial wallet identifier associated with the blockchain shell system is recorded on the blockchain. In the case of onboarding an NFT, the blockchain shell system can administrate the kinds of ownership verification procedures typically conducted to verify NFT ownership, such as those described in the background above. For example, the blockchain shell system could request that the owner encrypt a message with a private key associated with the NFT. After ownership verification is proved to the blockchain shell system in this manner, the NFT can be registered with the blockchain shell system such that later verifications of ownership can be conducted internally to the blockchain shell system.

Registering the NFT with the blockchain shell system can be accompanied by generating an NFT owner identifier such that it internally identifies the owner in the blockchain shell system and can be used with the blockchain shell system. In specific embodiments, the NFT owner identifier can then be stored on the owner's device and the NFT owner identifier can internally identify an owner of the owner device in the blockchain shell system. In specific embodiments, the NFT owner identifier can be provided to the owner's device in a bundle, as generated by a bundle generating system, that is compatible with a wallet application on the owner's device. The owner's device can be equipped with the capability to uniquely present the NFT owner identifier and may present the identifier in an encrypted encoding. Registering an NFT with the blockchain shell system can also include the blockchain shell system storing an NFT owner identifier in a database, may additionally include generating the NFT owner identifier for the NFT, and may additionally include storing ownership verification data in association with the NFT owner identifier in the blockchain shell system. The ownership verification data could be a full legal name of the owner, metadata stored with the NFT on the blockchain, the NFT address, and any other information that can be used to verify the owner's identity or to assist in the verification of ownership.

The NFT owner identifiers disclosed herein can take on various forms including a string of random characters generated by a random character generator administrated by the blockchain shell system, a full legal name of the owner of the NFT as registered with the blockchain shell system, a public wallet identifier of the NFT, a serial number uniquely identifying the NFT, and various other variants. These are all examples of NFT owner identifiers because identifying the NFT to the blockchain shell system also inherently identifies the owner to the blockchain shell system as the blockchain shell system can access the blockchain to determine ownership of a given NFT that is recorded on the blockchain. As applied in specific embodiments described below, the NFT owner identifier issued by the blockchain shell system can be a private NFT owner identifier. The private NFT owner identifier could be issued to the owner in an encrypted format such that it can be exchanged with the blockchain shell system through a verifier device or any public network while remaining private. In alternative embodiments, the NFT owner identifier issued by the blockchain shell system can be a public NFT owner identifier.

On demand NFT ownership verification can likewise be conducted in various ways. In specific embodiments of the invention, on demand ownership verification can be conducted entirely within the blockchain shell system. In these embodiments, if the NFT were previously registered with the blockchain shell system, verification could be conducted by accessing the internal databases of the blockchain shell system using the NFT owner identifier to see if the NFT was previously registered and looking up who the owner is. Alternatively, if the NFT was not previously registered, on demand NFT ownership verification could include registering the NFT with the system. For example, receipt of an NFT owner identifier in the form of a public wallet identifier, could trigger the blockchain shell system to run a cryptographic owner verification process with the owner. If the owner's contact information were stored by the blockchain shell system in association with the public wallet identifier, the owner could be contacted in this manner. If no such information were stored, the blockchain shell system could ask the verifier to obtain contact information from the owner to continue the registration flow.

NFT ownership verification conducted internally to the blockchain shell system could include a double check reference back to the blockchain to assure that the internal records of the blockchain shell system were current. The reference could involve checking to see if a public wallet identifier stored in association with the NFT in the blockchain shell system still matched the public wallet identifier stored on the blockchain. The NFT address of the NFT could be stored in association with the NFT in the blockchain shell system to facilitate this lookup. The double check could be conducted each time the blockchain shell system confirmed ownership. The double check could also be conducted on a periodic basis with a higher frequency allotted to NFTs that are not traded on the secondary market administrated by the blockchain shell system.

In specific embodiments of the invention, a physical representation of an NFT can be stored in a mobile smartphone wallet application on an owner device. The physical representation can be part of an electronic card stored in the mobile smartphone wallet in a similar fashion to the way credit cards are currently stored in mobile smartphone wallets. The electronic card can be distributed to the mobile smartphone in a bundle. The physical representation can also be part of its own card stored in a mobile smartphone wallet in the way that electronic cards and other custom issued cards are currently stored in wallet applications. Those of ordinary skill in the art will appreciate that the term “mobile smartphone wallet” and “wallet applications” in this disclosure are being used to refer to wallet applications such as those used for storing everyday payment methods and other electronic cards, and the term “wallet” in all other instances is being used to refer to the blockchain construct that includes a public wallet identifier and associated private key.

An electronic representation of an NFT (e.g., an electronic identification card) with an NFT owner identifier can be provided to an owner for storage in an electronic wallet in various ways. The electronic identification card can be issued for the NFT owner identifier. For example, the electronic identification card can be issued by the blockchain shell system when the NFT is registered with the NFT shell system. In specific embodiments of the invention, the electronic identification card can be issued to a user in a manner such that it will only function when operating with the mobile smartphone wallet of the owner of the NFT as registered with the blockchain shell system. In these embodiments, the fact that a user is able to present the NFT ownership identifier alone can be taken as a type of what-you-have security assurance provided on behalf of the blockchain shell system to the verifier. In alternative embodiments, the electronic identification card can be issued by a third party so long as the NFT owner identifier and physical representation are compatible with the blockchain shell system and the verifier device that is used to receive the NFT owner identifier. Such approaches will allow the blockchain shell system to onboard additional NFTs as part of the ownership verification process. In these approaches, a verifier may be provided with a prompt to request contact information from the owner in order to allow the blockchain shell system to contact the owner directly for verification.

The physical representation can include additional information besides the NFT owner identifier. For example, the physical representation can also include an identification of the NFT itself, the design and layout of the NFT, the serial number of the NFT, metadata associated with the NFT, or other information regarding the owner. In this manner, the additional information can be provided from the verifier to the blockchain shell system to allow the blockchain shell system to determine which NFT the verifier would like to verify ownership for. The response from the blockchain shell system to the verifier could then indicate that the NFT was valid and provide an identification of the NFT in addition to ownership verification data. However, this functionality can also be provided by the verifier device itself such that the physical representation does not necessarily need to identify an NFT. For example, if the verifier had a relationship with the blockchain shell system to indicate which NFT ownership would be requested for, then this information would not need to be provided with every ownership verification request. In keeping with this example, a verifier scanning QR codes and using the NFT blockchain shell to verify ownership of NFTs that provide access to a live event could send a request to the blockchain shell to see if the NFT owner identifier was associated with an NFT that provided access to the live event, and the physical representation would not need to encode such information.

The physical representation of the NFT can include information which allows the blockchain shell system to verify NFTs from multiple different blockchains. In specific embodiments in which the owner identifier is a public wallet identifier, the blockchain shell system could identify which blockchain the NFT was minted on by analyzing the format of the public wallet identifier. In alternative embodiments, the public wallet identifier and/or an identification of the blockchain could be stored by the blockchain shell system in association with the owner identifier. With the functionality described herein, a blockchain shell system would allow an owner to keep electronic identification cards associated with multiple different blockchains in a mobile wallet and provided verifiers with the ability to verify ownership of all the different types of NFTs with a single application and without having to interface with the different eccentricities of the various blockchains.

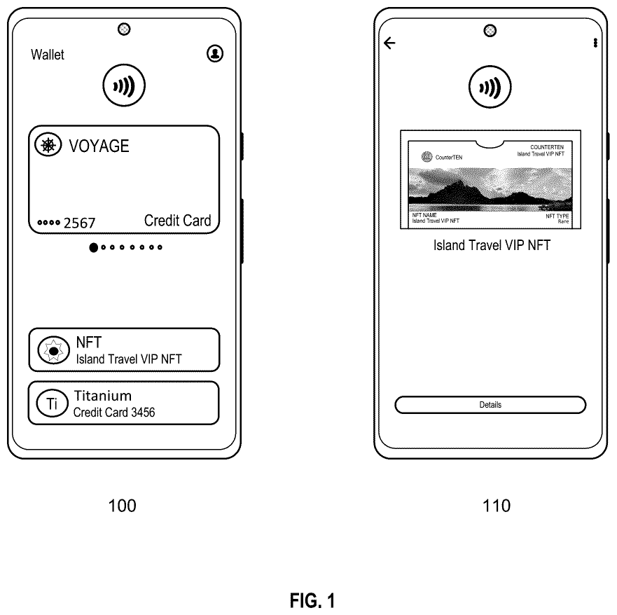

FIG. 1 is a rendering of the user interface of an electronic wallet application on a mobile device showing a selection screen 100 for a collection of electronic cards stored in the electronic wallet application and a display screen 110 for a particular electronic card in the form of an electronic representation of an NFT in accordance with specific embodiments of the inventions disclosed herein. Using such an approach, an owner would be able to manage and review their NFTs, from any number of blockchains, as easily as scanning through cards in a mobile application. Furthermore, the owner would be able to select the NFTs to obtain more information regarding the NFT or their ownership rights and present a physical representation of the NFT to a verifier in order for the verifier to verify the owner's ownership right in accordance with the approaches disclosed herein. As shown, the electronic representation of the NFT is an electronic card to display membership in a loyalty program and it is stored alongside other cards in a mobile wallet application that are not associated with NFTs. The mobile wallet application can be a standard wallet application such as Google Wallet or Apple Wallet and store any number of electronic cards along with the electronic representation of the NFT and any number of additional electronic representations of additional NFTs from the same or different blockchains.

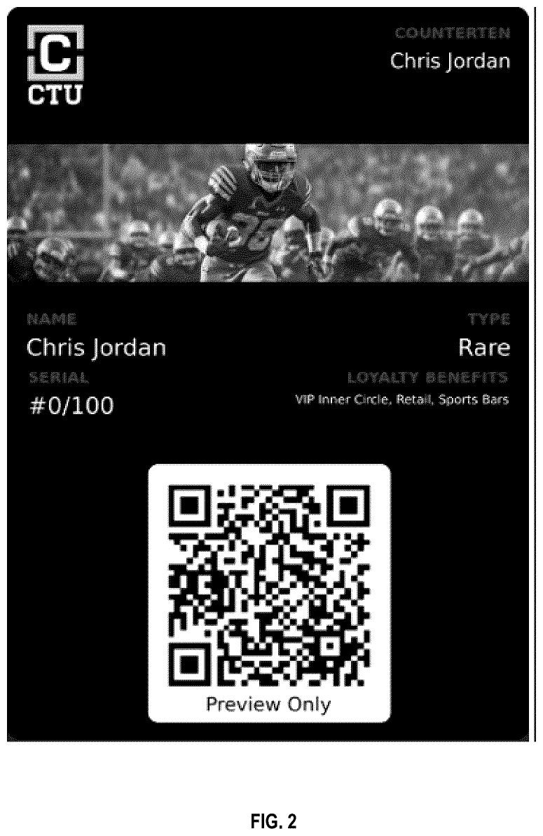

FIG. 2 is an example of a display on an owner device presenting a physical representation of an NFT owner identifier along with additional information. In the illustrated case, the physical representation is a QR code and the additional information includes metadata from the NFT and accompanying illustrations and other data. As mentioned previously, the accompanying illustrations and other data can be generated by the blockchain shell system when the NFT is registered with the system. Furthermore, the presented data can be encoded into a bundle by a bundle generating system as described above. The bundle can then be added to an electronic wallet. As such, the illustrated display shows what would be displayed after a user selected the NFT from their electronic wallet (e.g., after selecting the graphic for the electronic representation 111 in FIG. 1). The presented images and information could constitute the main content of an electronic representation of the NFT in a wallet application on the owner device. In a specific implementation, the owner could have searched through an electronic wallet application on their smartphone, such as by using selection screen 100, to find and select the electronic identification card to present the information to a verifier on the display of their smartphone.

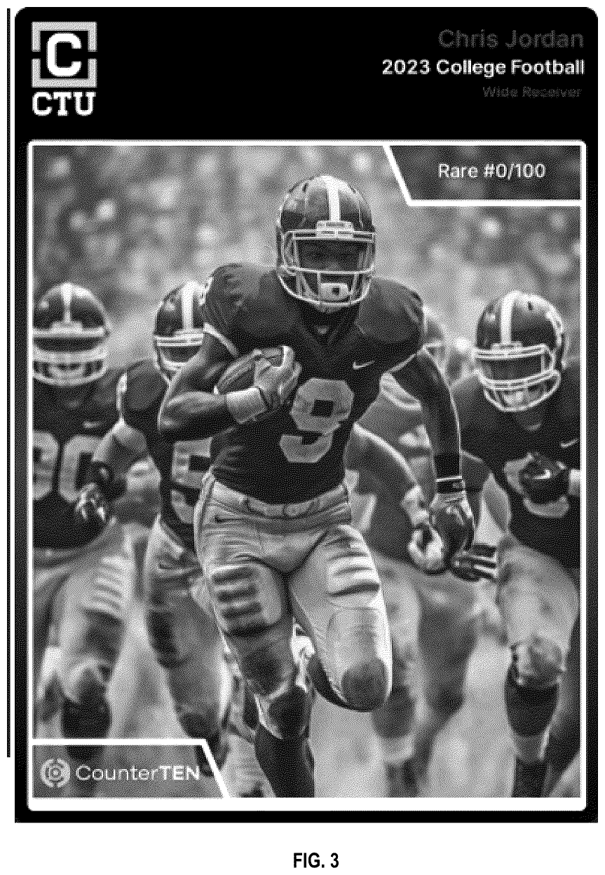

FIG. 3 is a rendering of an ownership verification page with ownership verification data of an NFT for presentation on a verifier device in accordance with specific embodiments of the invention disclosed herein. For example, the illustrated page could be displayed on the display of a verifier's smartphone. The ownership verification data in this implementation has been returned from the blockchain shell system in response to receipt of the NFT ownership identifier from the verifier's smartphone. In the illustrated case, the ownership verification data is a high-resolution image of an asset associated with the NFT as stored on the blockchain. In other approaches the ownership verification data could include a name of the owner as registered by the blockchain shell system and presented after the prompt “Owned By.” Additional information can also be returned such as metadata associated with the NFT (either stored on the blockchain or solely in the blockchain shell system), the public NFT address to allow the verifier to double check the blockchain, and a URL for the publicly available blockchain entry. In situations in which either the NFT ownership identifier is the public wallet identifier for the NFT or the blockchain shell system returns the public wallet identifier to the device along with the ownership verification data, the verifier can use the link to the NFT entry or the NFT address itself to double check that the public wallet identifiers match.

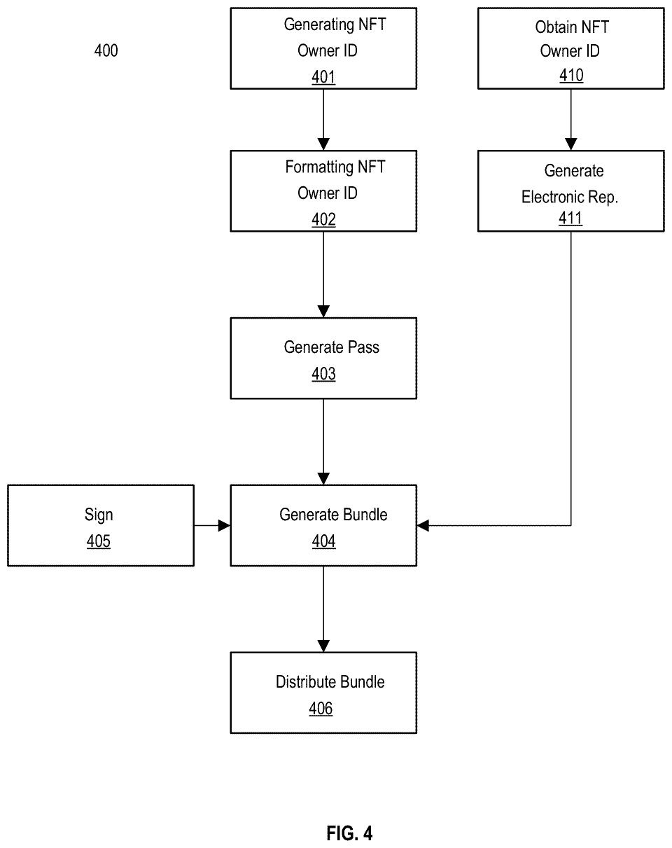

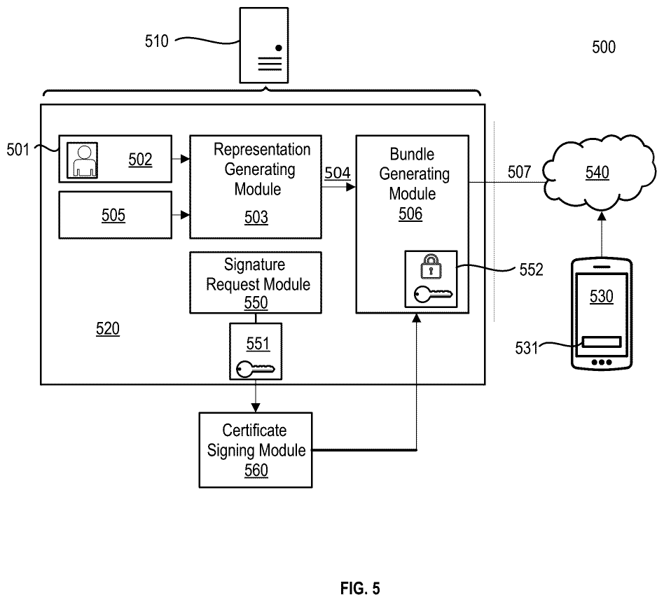

FIG. 4 is a flow chart 400 for a set of methods for distributing an electronic representation of an NFT in accordance with specific embodiments of the inventions disclosed herein. The steps of flow chart 400 can be conducted by a bundle generating system. The bundle generating system can be at least partially instantiated by one or more servers, as represented by server 510 in block diagram 500 in FIG. 5. The steps of the flow chart 400 can be conducted by one or more servers, as represented by server 510 in block diagram 500, configured to execute those steps. In specific embodiments, the servers can be configured to execute those steps by storing executable instructions to do so, and by having a network connection to a certificate signing module administrated by a wallet application administrator. In specific embodiments, the servers can be configured to execute those steps by storing executable instructions to do so, and by having a network connection to an owner device such as a mobile phone. One or more non-transitory computer-readable media, such as the main memories of the aforementioned one or more servers as represented by server 510, can store instructions that, when executed by one or more processors, such as the processors of the aforementioned one or more servers as represented by server 510, cause a system to execute methods in accordance with the steps in flow chart 400.

Flow chart 400 includes a step 410 of obtaining an NFT owner identifier for an NFT. The NFT owner identifier can identify the owner directly such as by being a legal name or user identifier for the user as registered with the bundle generating system. Alternatively, the NFT owner identifier can indirectly identify the owner such as by being an identifier of the NFT itself where ownership of the NFT can be determined by a blockchain shell system using the identifier of the NFT either by accessing an internal database or by accessing an associated blockchain. Depending upon its characteristics, the NFT owner identifier for the NFT can be obtained from storage on the bundle generating system, can be generated by the bundle generating system, or can be obtained from a blockchain on which the NFT is minted or transferred. For example, if the NFT owner identifier were previously generated by a blockchain shell system and already stored locally at the bundle generating system, the step could entail recalling the NFT owner identifier from memory. Alternatively, if the NFT owner identifier was a public wallet identifier or a blockchain address for an NFT, the step could entail either recalling the information from memory or accessing the blockchain to obtain the information.

In specific embodiments, flow chart 400 can include a step 401 step of generating the NFT owner identifier for an NFT which is a more specific and alternative step in comparison to step 410. For example, the NFT owner identifier could be a string generated by the bundle generating system which is associated, within a database administrated by the bundle generating system, with a specific NFT. Alternatively, the NFT owner identifier could be a string generated by the bundle generating system which is associated, with a specific NFT on a blockchain. For the avoidance of doubt, step 410 and step 411 are alternatives to step 401, step 402 and step 403.

Flow chart 400 also includes step 411 of generating an electronic representation of the NFT, wherein the electronic representation includes the NFT owner identifier. The electronic representation of the NFT could be an electronic card that includes the NFT owner identifier along with other information regarding the NFT such as metadata, a low-resolution image of a portion of the NFT (if the NFT is an image), data for a physical representation of the blockchain address of the NFT, a picture representing the NFT, links to access the blockchain shell system or blockchain to obtain further information about the NFT, and other information. The generating of the electronic representation can include generating a data object containing fields for all the required information and assigning the data to the data object. The generating of the electronic representation can include formatting the data into an interchange format.

In specific embodiments, flow chart 400 can include a step 402 of formatting the NFT owner identifier for a data exchange format and a step 403 of generating an electronic card. The data exchange format could be JavaScript Object Notation (JSON), extensible markup language (XML), resource description framework (RDF), comma separated values (CSV), or a proprietary data exchange format agreed upon by a wallet application administrator and the issuance administrator. The electronic card could be generated by instantiating a data object and propagating a collection of data into the data object. The electronic card could include the NFT owner identifier, data for visually displaying the NFT, and metadata associated with the NFT on the blockchain of the NFT. The data for visually displaying the NFT could be an image of the NFT, a lower resolution image of the NFT, an image of a portion of the NFT, or a pictorial description of the NFT. The NFT owner identifier could be stored in the electronic card along with data for physical representation of the NFT owner identifier such as a QR code or other visual encoding. The metadata could include a blockchain identifier for the NFT, a category of the NFT, a name of the NFT, a serial number of the NFT, a list of issuers associated with the NFT, a name of the issuance administrator for the NFT, an address of the NFT on a blockchain, a name of the blockchain on which the NFT is stored, a link to an explorer for the NFT along with the address of the NFT on the blockchain, and other data. The electronic card could be in a data exchange format. The data exchange format could be JavaScript Object Notation (JSON), extensible markup language (XML), resource description framework (RDF), comma separated values (CSV), or a proprietary data exchange format agreed upon by a wallet application administrator and the issuance administrator.

Flow chart 400 continues with step 404 of generating a bundle. The bundle can include the electronic card generated in step 403 or the electronic representation generated in step 411. The bundle can be compatible with a wallet application. The electronic representation of the NFT and the bundle can be compatible with the wallet application. Generating the bundle can include a step 405 of signing the bundle with a private key. In these embodiments, step 404 can comprise generating a bundle by signing the bundle with a private key. The signature can allow a recipient application (e.g., a specialized application from the issuance administrator or the wallet application itself) to use a public key to assure that none of the data in the bundle has been modified and to authenticate the issuer. In specific embodiments, a certificate associated with the private key can be signed by a developer of the wallet application (e.g., a wallet application administrator) as such, authenticating the issuer can include verifying that the issuer has been authorized by the wallet application administrator to issue bundles for the wallet application.

Flow chart 400 continues with a step 406 of distributing the bundle to an owner device via a network. The bundle can be distributed via the network to an owner device. The owner device can include the wallet application, and the owner can add the NFT to their wallet using the bundle. The bundle can be delivered via a web connection to the owner device, via an email connection, via a link sent using an SMS connection, or through an API to an application provided by the issuance administrator to the owner. The application can be separate from the wallet application and can be used to receive the bundle and add the NFT to the wallet application on the owner device. The application can include additional security measures such as requiring an owner to provide a credential such as a password they agreed upon with the issuance administrator when the NFT was minted by the issuance administrator, registered with the issuance administrator, or transferred to the custody of the issuance administrator.

FIG. 5 is a block diagram 500 for a system for generating and distributing an electronic representation of an NFT in accordance with specific embodiments of the inventions disclosed herein. The system includes a bundle generating system 520 which can be instantiated by one or more servers represented by server 510. The system can include a representation generating module 503 and a bundle generating module 506. The representation generating module 503 and the bundle generating module 506 can be instantiated by a cloud architecture as represented by server 510 in block diagram 500. The cloud architecture can include network connections to external entities such as a certificate signing authority of a wallet application administrator and owner devices for purposes of delivering generated bundles to the owner devices. The cloud architecture can be instantiated by one or more servers as represented by server 510.

The system includes a memory 502 storing an NFT owner identifier 501 for an NFT. The system also includes a representation generating module 503 configured to generate an electronic representation of the NFT 504. The representation generating module can be instantiated by a server routine which is capable of formatting the NFT owner identifier and additional information (stored in memory 505) into a data object. The server routine can instantiate a data object, pull the associated data from memory, reformat the data for the data object, and store the data object back in memory or pass the data object to the next module as the electronic representation of the NFT 504. Bundle generating system 520 also includes a bundle generating module 506 configured to generate a bundle 507. The bundle 507 includes the electronic representation of the NFT 504. The bundle generating module 506 can be instantiated by a server routine which is capable of addressing the electronic representation of the NFT 504, packetizing the electronic representation of the NFT 504, encrypting the electronic representation of the NFT 504, and formatting the electronic representation of the NFT 504 for delivery to and management by wallet application 531 on owner device 530. The bundle 507 can be addressed for distribution to an owner device 530 via a network 540. The owner device 530 can be a smartphone. In specific embodiments of the invention, the electronic representation of the NFT 504 and the bundle 507 are compatible with the wallet application 531. The wallet application 531 can be compatible with the bundle 507 such that the NFT owner identifier 501 can be stored on and managed on owner device 530.

The bundle generating system can be configured to provide authentication and verification services for the bundles generated thereby to allow the owner devices to add generated bundles to their devices in compliance with the requirements of the wallet application administrators. The bundle generating system 520 can include a signature request module 550. The signature request module 550 can be configured to communicate with a certificate singing system to have the certificate associated with a private key signed by the certificate singing system. The certificate signing system can include a certificate signing module that is configured to sign a certificate signing request 551 for a private key sent by a signature request module 550 to thereby generate a signed private key certificate 552. The signed private key certificate can include a private key generated by the certificate signing system which can then be used by bundle generating module 506 to sign the bundles generated thereby. In according embodiments, the representation generating module 503 can be configured to format the NFT owner identifier 501 for a data exchange format, the electronic representation of the NFT 504 can be in the data exchange format, the bundle generating module 506 can be configured to generate the bundle 507 by signing the electronic representation in the data exchange format using a private key in signed private key certificate 552, and the signed private key certificate 552 associated with the private key can be signed by an administrator of the wallet application 531 using certificate signing module 560.

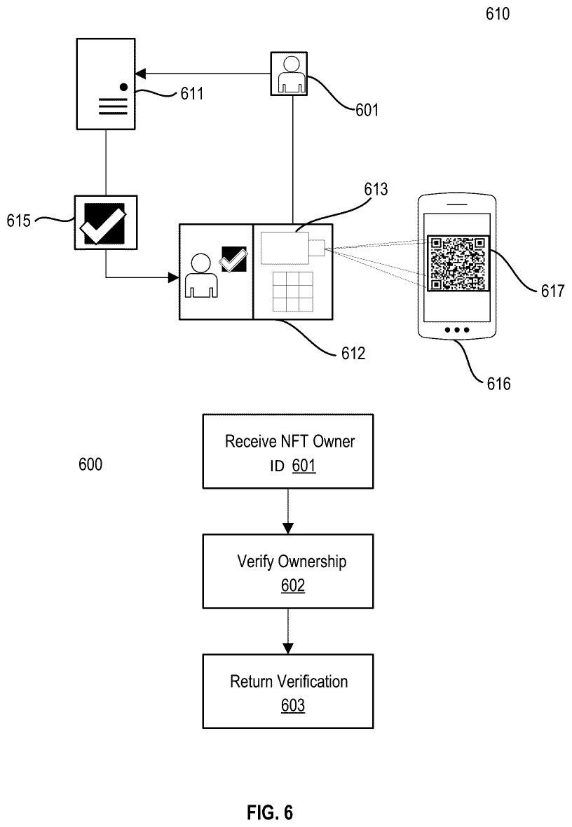

FIG. 6 includes a block diagram 610 for a system and a flow chart 600 for a set of methods for verifying an NFT owner identifier in accordance with specific embodiments of the inventions disclosed herein. The steps of flow chart 600 can be conducted by a blockchain shell system. The blockchain shell system can be at least partially instantiated by one or more servers, as represented by server 611 in block diagram 610. The steps of the flow chart 600 can be conducted by one or more servers, as represented by server 611 in block diagram 610, configured to execute those steps. The servers can be configured to execute those steps by storing executable instructions to do so, by having a network connection to a verifier device and optionally to an owner device, and by having access to an internal database and/or a blockchain. One or more non-transitory computer-readable media, such as the main memories of the aforementioned one or more servers as represented by server 611, can store instructions that, when executed by one or more processors, such as the processors of the aforementioned one or more servers as represented by server 611, cause a system to execute methods in accordance with the steps in flow chart 600.

Flow chart 600 beings with a step 602 of receiving an NFT owner identifier from a verifier device, wherein the NFT owner identifier was displayed on the owner device for the verifier device, at a locale, using an electronic representation of the NFT (e.g., an electronic card). In specific embodiments, this step can be preceded by an owner opening a wallet application on their owner device (e.g., a mobile phone) and scanning through a collection of potential electronic representations of their various NFTs in order to select the correct one for presenting to the verifier. The step can be conducted at a locale in which both an owner device such as owner device 616, in the form of a mobile phone, and a verifier device 612, in the form of a dedicated verifier device, are located. In alternative approaches the verifier device can be a personal computer, laptop, turnstile, access point controller, mobile phone, or other device. In block diagram 610, the NFT owner identifier is represented by a physical representation of the NFT owner identifier 617 in the form of a displayed QR code. In alternative approaches, the physical representation can be an audio file, a different kind of visual encoding, an encoding accessible through a mechanical electronic interface such as a USB interface, or an electromagnetically transmitted encoding of the NFT owner identifier. In block diagram 610, the verifier device includes a visible light sensor 613 for scanning the physical representation of the NFT owner identifier 617 in the form of a displayed QR code. In alternative embodiments, the verifier device 612 will include alternative sensors to obtain the physical representation of the NFT owner identifier such as a microphone, touch pad, socket, or radio receiver.

Flow chart 600 continues with a step 603 of verifying ownership of the NFT using the NFT owner identifier. As illustrated, this step can involve verifier device 612 parsing the physical representation of the NFT, obtaining the NFT owner identifier 601 therefrom, and transmitting the NFT owner identifier to blockchain shell system instantiated by server 611. The blockchain shell system instantiated by server 611 can be part of the same system or cloud architecture as bundle generating system 520 from FIG. 5. The NFT owner identifier 601 can be sent in encrypted form through a web connection between the blockchain shells system instantiated by server 611 and verifier device 612 or through an API between an application on verifier device 612 and the blockchain shell system instantiated by server 611.

Flow chart 600 continues with a step 604 of returning ownership verification data of the NFT 615 to the verifier device. The ownership verification data can be sent after the blockchain shell system determines that the NFT is actually owned by the NFT owner identifier 601 and/or by the owner of owner device 616. The ownership verification data can be displayed on verifier device. For example, as in FIG. 3, the full legal name of an owner could be delivered to the verifier device with the ownership verification data and the verifier could then check that the holder of the owner device had the same full legal name. Alternative processes for verification of ownership of the NFT are described in U.S. patent application Ser. No. 18/118,772 as filed on Mar. 7, 2023, and incorporated by reference herein in its entirety for all purposes.

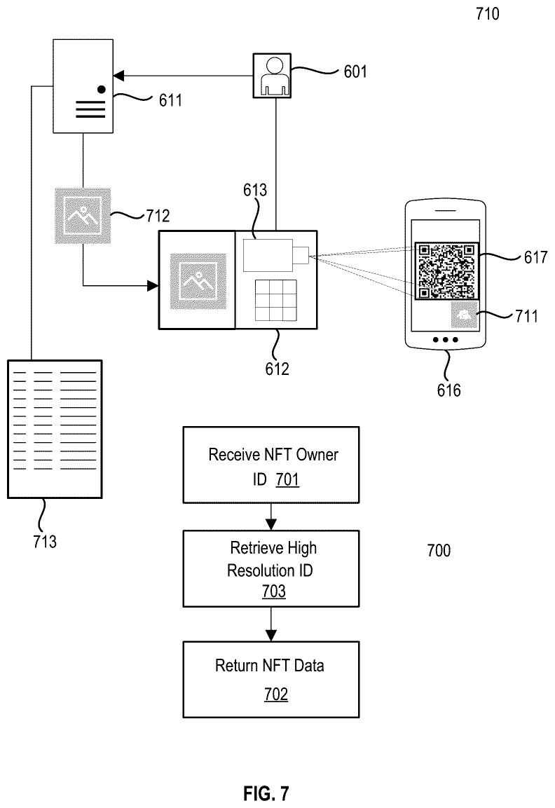

FIG. 7 includes a block diagram 710 for a system and a flow chart 700 for a set of methods for accessing information from a blockchain 713 based on an electronic representation of an NFT in accordance with specific embodiments of the inventions disclosed herein. Common elements between FIG. 6 and FIG. 7 utilize the same reference numbers. Flow chart 700 beings with a step 701 of receiving an NFT owner identifier. This step can be conducted in much the same way as step 602 from flow chart 600. The NFT owner identifier can identify the owner directly by being an identifier used to identify the owner in the blockchain shell system instantiated by server 611, can indirectly identify the owner by being an identifier for an NFT which the blockchain shell system instantiated by server 611 knows is owned by the owner, or can indirectly identify the owner by allowing the blockchain shell system instantiated by server 611 to access blockchain 713 to determine the recorded owner on the blockchain. A physical representation of NFT owner identifier can be displayed on the owner device 616, for the verifier device 612 to obtain, using an electronic card stored on owner device 616 and distributed according to the processes and systems described in FIG. 4. Flow chart 700 continues with a step of returning data of the NFT from the blockchain 713 of the NFT, to the verifier device 612 upon receiving the NFT owner identifier 601. This step can be conducted by the blockchain shell system instantiated by server 611 upon verifying the ownership of the NFT or upon identifying the NFT using the NFT owner identifier. The blockchain shell system instantiated by server 611 can be configured to retrieve the data associated with the NFT from blockchain 713 after receiving the NFT owner identifier 601 from verifier device 612.

The data that is returned to the verifier device can take various forms. For example, the data could be a full name of the owner of the NFT, metadata associated with the NFT, an address of the NFT on blockchain 713, or other data. In specific embodiments of the invention, the data returned could be a high-resolution image of an asset associated with the NFT. The high-resolution image could be stored locally on the blockchain shell system or it could be accessed from the blockchain 713 by the blockchain shell system instantiated and delivered to the verifier device.

In accordance with the embodiments discussed above where the NFT is associated with an image minted on the blockchain, and the block chain shell system accesses the blockchain to retrieve the image, flow chart 700 includes an optional step 703 of retrieving a high-resolution image of an asset associated with the NFT from a blockchain after the NFT owner identifier is received from a verifier device. This step could be conducted by blockchain shell system, as represented by server 611, being configured to retrieve a high-resolution image 712 of an asset associated with the NFT from a blockchain after receiving the NFT owner identifier 601 from a verifier device 612. In these embodiments, step 702 could involve returning a high-resolution image 712 of an asset associated with the NFT to the verifier device upon receiving the NFT owner identifier. In these embodiments, the electronic representation of the NFT (e.g., an electronic card) could include a low-resolution image of at least a portion of the asset associated with the NFT. Using this approach, high-resolution images would not be needed to be stored on the wallet application and result in violations of the storage requirements of the wallet applications or unwanted decreases in the responsiveness of the wallet application. However, using these approaches, the low-resolution image could still be displayed along with other information in the electronic representation of the NFT, such as low-resolution image 711, which would allow an owner to quickly identify the NFT they wanted to recall, and to actually receive the high-resolution image of the NFT. Similar approaches could be used for NFTs with animations or interactivity where the full data for the NFT stored on the blockchain or blockchain shell system could be retrieved on demand using the electronic representation of the NFT on an owner device, without the full data being continuously stored on the owner device.

In specific embodiments of the invention, the blockchain shell system can deliver the same data to the owner device described above in response to the selection of an interface element in the wallet application. For example, an owner may be able to retrieve a high-resolution image of the NFT, an animation associated with the NFT, or an interactive application associated with the NFT and have it delivered to the owner device upon selection of an interface element in the wallet application that appears whenever the electronic representation of the NFT is selected in the wallet application. While not illustrated, the approach would be similar to FIG. 7, but without the verifier device, and with the returned data being provided directly to the owner device instead.

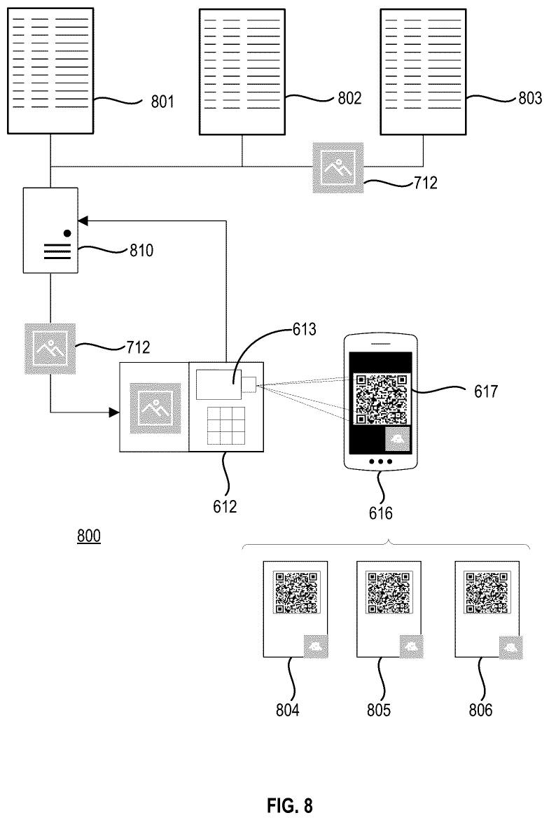

FIG. 8 includes a block diagram 800 for a system for accessing information from a plurality of blockchains (i.e., blockchain 801, blockchain 802, and blockchain 803) based on an electronic representation of an NFT in accordance with specific embodiments of the inventions disclosed herein. Common elements between FIG. 7 and FIG. 8 utilize the same reference numbers. Block diagram 800 differs from block diagram 710 in that blockchain shell system 810 is configured and programmed to access multiple blockchains. As a result, the issuance administrator associated with blockchain shell system 810 is able to administrate the issuance of electronic representations associated with more than one blockchain and/or allow users to organize NFTs in a single wallet application even if the NFTs are registered on different blockchains. Accordingly, a user can scan through the wallet application on owner device 616 and review electronic representation 804 associated with blockchain 801, electronic representation 805 associated with blockchain 802, and electronic representation 806 associated with blockchain 803. Then, upon selecting an interface element displayed in association with electronic representation 806, the user can display physical representation of the NFT owner identifier 617 associated with electronic representation 806, and verifier device 612 can be used to cause blockchain shell system 810 to access high-resolution image 712 from blockchain 803 for display on verifier device 612. Furthermore, the same process could be followed regardless of which electronic representation was selected without verifier device 612 or owner device 616 having to be configured to interface with the different blockchains.

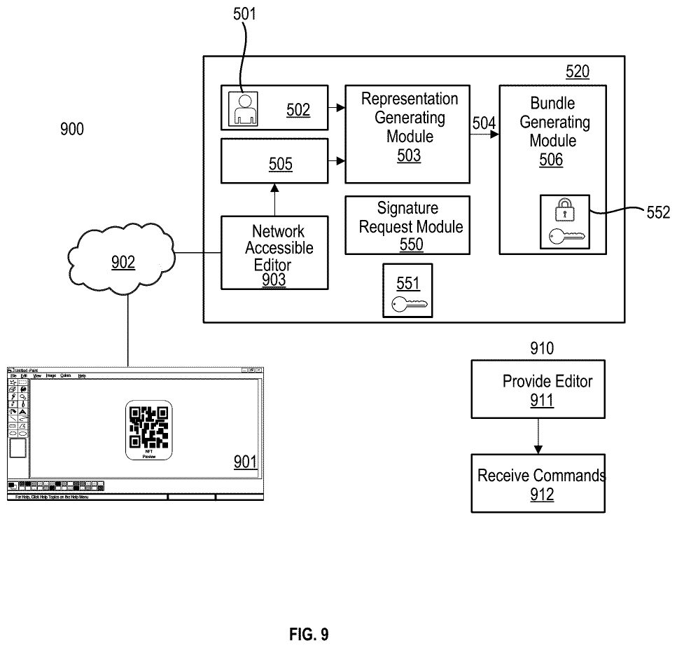

FIG. 9 includes a block diagram 900 for a system and a flow chart 910 for a set of methods for providing an issuer with network accessible tools for defining an electronic representation of an NFT in accordance with specific embodiments of the inventions disclosed herein. Similar elements from FIG. 5 are labeled using the same reference numbers in FIG. 9. Flow chart 910 includes a step 911 of providing a network accessible editor to an issuer of an NFT. The network accessible editor can be instantiated by the one or more servers that are used to instantiate bundle generating system 520. The server can be configured to provide access to a network accessible editor 903 to an issuer of the NFT. Access to the network accessible editor can be provided via a network such as network 902.

The issuer can use the network accessible editor to define the electronic representation of the NFT including the data that appears with the electronic representation of the NFT when the electronic representation is provided to a wallet application and the overall look and feel of the electronic representation as it appears in the wallet application. The issuer could use the editor to select which wallet application the electronic representation of the NFT will be compatible with. The commands can be provided in a user interface presented to a user such as interface 901. The user interface can be a wizard type of interface which accepts selections from radio buttons or drop-down menu interface elements. The user interface can also be a WYSIWYG type of interface which allows a higher degree of customizability when defining the electronic representation including adding images and defining lines and shapes to the electronic representation. In specific embodiments of the invention, the issuer will also be the owner of the NFT and will be able to user an editor such as network accessible editor 903 to design and issue electronic representations of their own NFT collection.

Flow chart 910 also includes a step 912 of receiving commands for the data for visually displaying the NFT and the electronic representation of the NFT (e.g., an electronic card) from the issuer of the NFT via the network accessible editor. Accordingly, the one or more servers that instantiate bundle generating system 520 can be configured to receive commends for the data for visually displaying the NFT and the electronic representation from the issuer of the NFT via a network accessible editor. For example, the commands can be entered into the interface 901, sent through network 902, and received by the network accessible editor 903 in bundle generating system 520. The commands can include a description of at least one of the layout, colors, content and messaging of the electronic representation. The description of the electronic representation can then be stored in memory 505 to be used by representation generating module 503 to generate the electronic representation. In specific embodiments of the invention, the network accessible editor can be instantiated using different servers than those used to instantiate the bundle generating system. In specific embodiment of the invention, a definition of the electronic representation can be uploaded to the bundle generating system by a user where the definition was produced using requirements specified by the issuance administrator using a separate editing tool selected by the issuer.

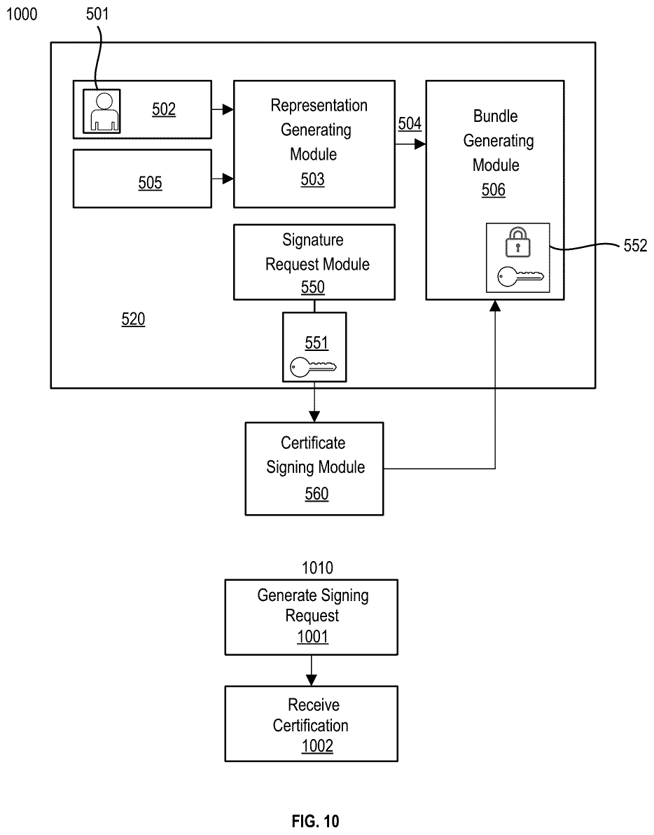

FIG. 10 includes a block diagram 1000 for a system and a flow chart 1010 for a set of methods for receiving a certification for a private key to be used to generate a bundle including the electronic representation of the NFT in accordance with specific embodiments of the inventions disclosed herein. Similar elements from FIG. 5 are labeled using the same reference numbers in FIG. 10. Flow chart 1010 includes a step 1001 of generating a certificate signing request for the developer of the wallet application and a step 1002 of receiving a certification for the private key in exchange for the certificate signing request. The certificate signing request can allow owner device that receive bundles generated by bundle generating system 520 to confirm that the private key used to sign the bundles was certified by the wallet application administrator. Bundle generating system 520 includes a signature request module 550 configured to generate a certificate signing request 551 for the developer of the wallet application to certify a private key. Once the certificate is signed by a certificate signing module 560, the signed private key certificate 552 can be stored by bundle generating module 506. As illustrated, certificate signing module 560 is an external system that is in networked communication with bundle generating system 520.

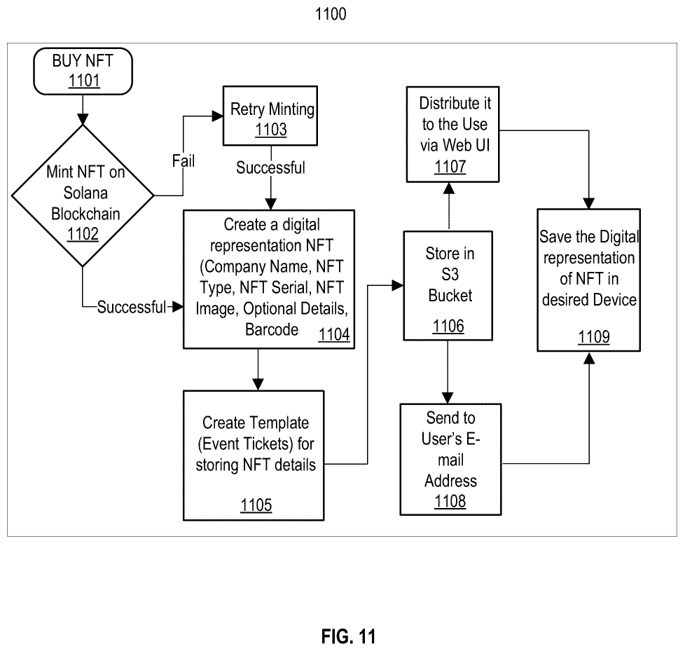

FIG. 11 is a flow chart 1100 for a set of methods that illustrate and provide examples for specific embodiments of the invention disclosed above. The flow chart begins with a step 1101 of buying an NFT which can be conducted by a person who is purchasing an NFT from an issuer with the desire to be an owner of the NFT. This action leads to step 1102 of the issuance administrator minting the NFT on a blockchain (in this example, the blockchain is the Solana blockchain). In specific embodiments, an NFT owner identifier can be generated during the minting and included in the data created in step 1104 described below. In specific embodiments, an electronic card that is generated in step 1105 described below can be a low-resolution image of an asset associate with the NFT and the minting of the NFT in step 1102 can include minting a high-resolution image of the asset on a blockchain. The process can either fail, in which case it is followed by multiple retry attempts at minting the NFT in step 1103 or is followed by the successful generation of an electronic representation of the NFT in step 1104. In specific embodiments, the generating of the electronic representation of the NFT can include the generation of an NFT owner identifier. However, in alternative embodiments, the electronic representation of the NFT can include an NFT owner identifier that was already available from the minting process. The electronic representation can store all the data for the NFT in JSON format. The electronic representation can be an electronic card that is compatible with an electronic wallet identifier. The process can then continue with a step 1105 of creating a template for storing the electronic representation into a wallet application. The template can be created using the process described above with reference to FIG. 9 where the received commands define the template. Step 1105 can involve retrieving these commands from memory and instantiating a template for receiving the data from step 1104. The flow chart can then continue with a step 1106 of storing the template in a simple storage service (S3) bucket. In specific embodiments of the invention, a bundle generated using the electronic representation, using the processes described above, can be stored in the S3 bucket. The template or bundle can then be distributed using either a web accessible user interface in a step 1107 or be sent to an owner's email address in a step 1108. The owner can then use the template or bundle to bring an electronic representation of their NFT into their wallet application on their computer, smartphone, or other owner device. The owner can then store the representation of the NFT in their wallet application in a step 1109 to be safeguarded for later access and presentation for verification.

Once the physical representation of the NFT is stored in the mobile smartphone wallet application, it can be managed by an owner in various ways. For example, an owner could swipe through all their NFTs in a carousel type of user interface to scan for one they are searching for and stop the carousel when they have found a particular physical representation. The different styles, fonts, illustrations etc. associated with each of the NFTs could contribute to making these searches easier. In specific embodiments, the users could be able to customize the presentation of the physical representations such as by altering the way they are able to scroll through the collection, altering the order in which the physical representations appear in the collection, and to be able to remove the NFT from the mobile wallet and add it back in at a later time. For example, if a particular NFT were for a piece of digital artwork, the background of the physical representation of the NFT could be the digital artwork itself, and the additional information presented by the wallet application could be selectively hidden so that the user could either present the additional information or remove it so that the digital artwork alone could be considered or show cased by the user. In specific embodiments of the invention, the user could also be given the opportunity to organize the NFTs into different categories or folders in the wallet application in order to make them easier to manage and search through.

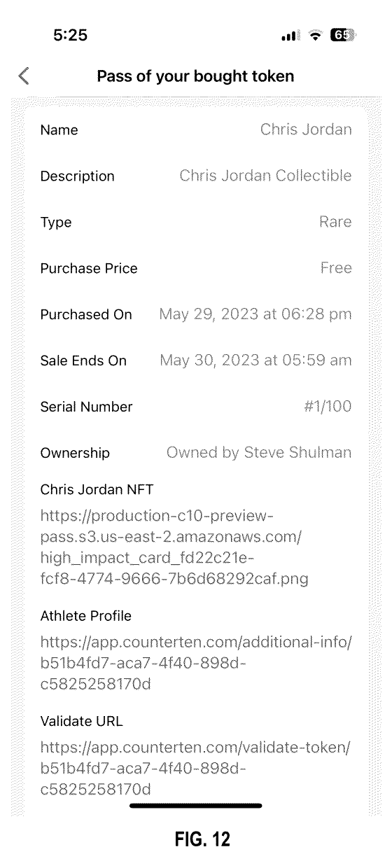

FIG. 12 is a screen shot of the pass details page for an electronic representation of an NFT in a wallet application. This page could be accessed within a wallet application upon clicking the card details of the stored card in the wallet application. As seen, the page includes additional data regarding the NFT and the electronic representation of the NFT including a URL to validate ownership of the NFT at the bottom of the screenshot.

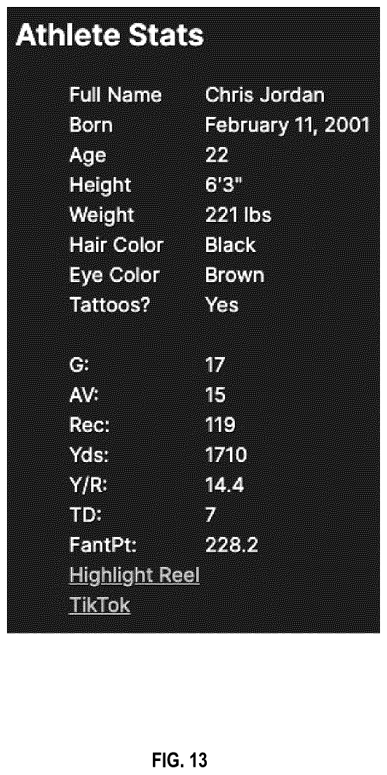

FIG. 13 is a partial screen shot of additional information that can be provided to a verifier device, or to an owner device, in connection with an electronic representation of an NFT in a wallet application in the form of statistics for an athletic collectible card. The additional information can be provided along with a high-resolution image of an asset associated with the NFT such as by being sent along with image 712 from the server.

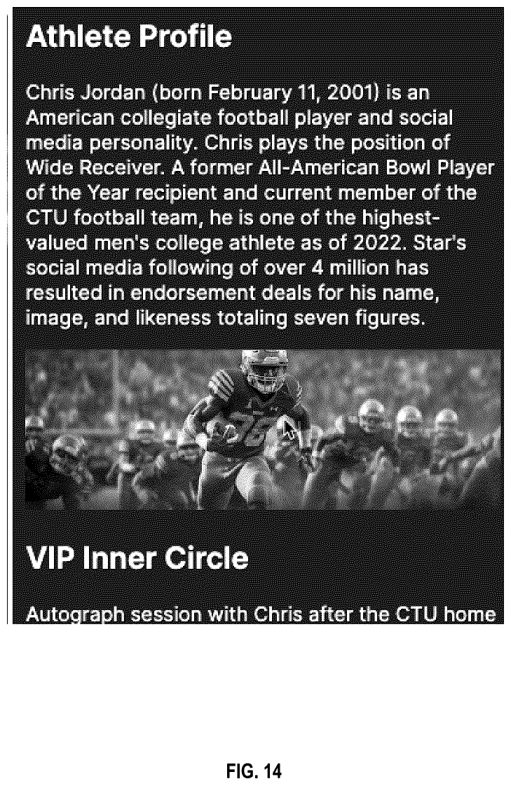

FIG. 14 is a partial screen shot of additional information that can be provided to a verifier device, or to an owner device, in connection with an electronic representation of an NFT in a wallet application in the form of a player summary for an athletic collectible card. The additional information can be provided along with a high-resolution image of an asset associated with the NFT such as by being sent along with image 712 from the server.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, while the example of an NFT stored on a mobile smartphone wallet was used throughout this disclosure, the wallet application and the associated collections of NFTs could also be accessible to users through alternative channels such as a web portal accessible to any web connected device. These and other modifications and variations to the present invention may be practiced by those skilled in the art, without departing from the scope of the present invention, which is more particularly set forth in the appended claims.

What is claimed is:

1. A method for generating and distributing an NFT owner identifier comprising:
generating the NFT owner identifier for an NFT;
formatting the NFT owner identifier for a data exchange format;
generating an electronic card, wherein the electronic card includes the NFT owner identifier, data for visually displaying the NFT, and metadata associated with the NFT on a blockchain of the NFT, and wherein the electronic card is in the data exchange format;
generating a bundle by signing the electronic card using a private key; and
distributing the bundle to an owner device via a network;
wherein the bundle is compatible with a wallet application, and a certificate associated with the private key is signed by a wallet application administrator.

2. The method of claim 1, further comprising:
receiving the NFT owner identifier from a verifier device, wherein the NFT owner identifier was displayed on the owner device for the verifier device, at a locale, using the electronic card;
verifying ownership of the NFT using the NFT owner identifier; and
returning ownership verification data of the NFT to the verifier device.

3. The method of claim 1, further comprising:
receiving the NFT owner identifier from a verifier device, wherein the NFT owner identifier was displayed on the owner device for the verifier device, at a locale, using the electronic card;
retrieving data of the NFT from a blockchain after receiving the NFT owner identifier from the verifier device; and
returning the data of the NFT, retrieved from the blockchain of the NFT, to the verifier device.

4. The method of claim 1, further comprising:
receiving the NFT owner identifier from a verifier device, wherein the NFT owner identifier was displayed on the owner device for the verifier device, at a locale, using the electronic card; and
returning a high-resolution image of an asset associated with the NFT to the verifier device upon receiving the NFT owner identifier;
wherein the electronic card includes a low-resolution image of at least a portion of the asset associated with the NFT.

5. The method of claim 4, further comprising:
retrieving the high-resolution image of the asset associated with the NFT from a blockchain after receiving the NFT owner identifier from the verifier device.

6. The method of claim 1, further comprising:
providing a network accessible editor to an issuer of the NFT; and
receiving commands for the data for visually displaying the NFT and the electronic card from the issuer of the NFT via the network accessible editor;
wherein the commands include a description of at least one of a layout, colors, content and messaging of the electronic card.

7. The method of claim 1, further comprising:
minting the NFT, wherein the NFT owner identifier is generated during the minting;
wherein: (i) the electronic card includes a low-resolution image of an asset associated with the NFT; and; (ii) the minting of the NFT includes minting a high-resolution image of the asset on a blockchain.

8. The method of claim 1, further comprising:
generating a certificate signing request for the wallet application administrator; and
receiving a certification for the private key in exchange for the certificate signing request;
wherein the data exchange format is JavaScript Object Notation.

9. The method of claim 1, wherein:
the wallet application is compatible with a smartphone;
the wallet application is programmed to display a physical representation of the NFT owner identifier; and
data for the physical representation of the NFT owner identifier is in the bundle.

10. The method of claim 1, wherein:
the wallet application is compatible with a smartphone;
the wallet application is programmed to display a physical representation of a blockchain address for the NFT; and
data for the physical representation of the blockchain address is in the bundle.

11. A method for distributing an NFT owner identifier comprising:
obtaining the NFT owner identifier for an NFT;
generating an electronic representation of the NFT, wherein the electronic representation includes the NFT owner identifier;
generating a bundle, wherein the bundle includes the electronic representation; and
distributing the bundle to an owner device via a network;
wherein the bundle is compatible with a wallet application.

12. The method of claim 11, wherein:
the electronic representation of the NFT and the bundle are compatible with a wallet application.

13. The method of claim 11, further comprising:
formatting the NFT owner identifier for a data exchange format, wherein the electronic representation of the NFT is in the data exchange format; and
generating the bundle by signing the electronic representation in the data exchange format using a private key;
wherein a certificate associated with the private key is signed by a developer of the wallet application.

14. The method of claim 13, further comprising:
receiving the NFT owner identifier from a verifier device, wherein the NFT owner identifier was displayed on the owner device to the verifier device, at a locale, using a physical representation of the NFT owner identifier;
verifying ownership of the NFT using the NFT owner identifier; and
returning ownership verification data of the NFT to the verifier device.

15. The method of claim 13, further comprising:
receiving the NFT owner identifier from a verifier device, wherein the NFT owner identifier was displayed on the owner device to the verifier device, at a locale, using the electronic representation of the NFT; and
returning a high-resolution image of an asset associated with the NFT to the verifier device upon receiving the NFT owner identifier;
wherein the electronic representation of the NFT includes a low-resolution image of at least a portion of the asset associated with the NFT.

16. The method of claim 15, further comprising:
retrieving the high-resolution image of the asset associated with the NFT from a blockchain after receiving the NFT owner identifier from the verifier device.

17. The method of claim 12, further comprising:
minting the NFT, wherein the NFT owner identifier is generating during the minting.

18. The method of claim 12, wherein:
the wallet application is compatible with a smartphone;
the wallet application is programmed to display a physical representation of the NFT owner identifier; and
data for the physical representation of the NFT owner identifier is in the bundle.

19. The method of claim 12, wherein:
the wallet application is compatible with a smartphone;
the wallet application is programmed to display a physical representation of a blockchain address for the NFT; and
data for the physical representation of the blockchain address is in the bundle.

20. A system for generating and distributing an NFT owner identifier comprising:
a memory storing an NFT owner identifier for an NFT;
a representation generating module configured to generate an electronic representation of the NFT, wherein the electronic representation includes the NFT owner identifier; and
a bundle generating module configured to generate a bundle, wherein the bundle includes the electronic representation and wherein the bundle is addressed for distribution to an owner device via a network.

21. The system of claim 20, wherein:
the representation generating module and the bundle generating module are instantiated by a cloud architecture; and
the electronic representation of the NFT and the bundle are compatible with a wallet application.

22. The system of claim 20, further comprising:
a server configured to: (i) provide access to a network accessible editor to an issuer of the NFT; (ii) receive commands for data for visually displaying the electronic representation of the NFT from the issuer of the NFT via the network accessible editor;
wherein the commands include a description of at least one of a layout, colors, content and messaging of the electronic representation.

23. The system of claim 20, further comprising:
a blockchain shell system configured to retrieving a high-resolution image of an asset associated with the NFT from a blockchain after the NFT owner identifier is received from a verifier device;
wherein the electronic representation includes a low-resolution image of at least a portion of the asset associated with the NFT.

24. The system of claim 20, wherein:
the representation generating module is further configured to format the NFT owner identifier for a data exchange format;
the electronic representation of the NFT is in the data exchange format;
the bundle generating module is further configured to generate the bundle by signing the electronic representation in the data exchange format using a private key;
the bundle is compatible with a wallet application; and
a certificate associated with the private key is signed by a developer of the wallet application.

25. The system of claim 24, further comprising:
a signature request module configured to generate a certificate signing request for the developer of the wallet application to certify a private key;
wherein the data exchange format is JavaScript Object Notation.
